(19) United States
(12) Patent Application Publication
(10) Pub. No.: US 2025/0208716 A1
(43) Pub. Date: Jun. 26, 2025

(54) SYSTEM INTERFACE FOR THE VISUALLY IMPAIRED

(71) Applicant: Brown University, Providence, RI (US)

(72) Inventor: Joseph ROVAN, Providence, RI (US)

(21) Appl. No.: 18/991,010

(22) Filed: Dec. 20, 2024

Related U.S. Application Data
(60) Provisional application No. 63/614,222, filed on Dec. 22, 2023.
(60) Provisional application No. 63/699,058, filed on Sep. 25, 2024.

(51) Int. Cl. G06F 3/01; G06F 3/04847; G06F 3/04886; G06F 3/16

(52) U.S. Cl. CPC G06F 3/016; G06F 3/04847; G06F 3/04886; G06F 3/167

(57) ABSTRACT

An asymmetric interface for manipulating a system comprises a panel supporting a plurality of controls, where the plurality of controls is divided into a plurality of functional blocks based upon underlying system function, and wherein the controls of each block have an asymmetric relationship to each other and a unique orientation with respect to the orientation of controls in other blocks.

### CROSS-REFERENCE TO RELATED APPLICATIONS

The present application claims benefit of priority to U.S. Provisional Application No. 63/614,222 filed Dec. 22, 2023, and to U.S. Provisional Application No. 63/699,058 filed Sep. 25, 2024, and which are both incorporated by reference as if fully set forth herein.

### BACKGROUND

### Field

The present disclosure relates to an interface to allow visually impaired people to access and control a system.

### Description of the Problem and Related Art

In the realm of user interface design, the need for intuitive and efficient control mechanisms is paramount, especially as systems become increasingly complex and multifunctional. Traditional interfaces often rely on visual cues and symmetrical layouts, which can sometimes lead to user confusion and inefficiency, particularly in high-stress or low-visibility environments. The challenge is to create an interface that not only simplifies the user experience but also enhances it through multi-sensory feedback mechanisms.

As technology advances, the demand for more sophisticated control systems in various applications, such as digital audio systems, digital lighting systems, video editing systems, and other computer-based systems, continues to grow. These systems require interfaces that can provide clear, unambiguous feedback to the user, allowing for precise and efficient manipulation. The integration of tactile, haptic, and audible feedback into interface design is a promising approach to meet these needs, offering a more immersive and responsive user experience. However, achieving a balance between complexity and usability remains a significant challenge in the field.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

In accordance with embodiments, an asymmetric interface for manipulating a system is provided. The interface comprises a panel supporting a plurality of controls, which are divided into multiple blocks based on the underlying system function. Each block of controls has an asymmetric relationship to each other and a unique orientation with respect to the orientation of controls in other blocks.

In accordance with other embodiments, the asymmetric interface system includes each of the plurality of blocks separated by a space to delineate between blocks.

In yet other embodiments, the asymmetric interface system further comprises orientation guides disposed between blocks, providing tactile delineation between blocks. Each orientation guide has a unique tactile surface to differentiate the blocks.

In accordance with further embodiments, the tactile surfaces of the orientation guides include at least one of raised strips with unique textures and patterns of raised bumps.

In other embodiments, each block in the asymmetric interface system is configured with a unique haptic cue.

In accordance with additional embodiments, the haptic cue in each block may be varied by at least one of frequency, duration, waveform, and pattern vibration.

In yet other embodiments, the vibration frequency of the haptic cue may range from sub-audio to about 1.5 kHz.

In accordance with other embodiments, each block in the asymmetric interface system is configured with unique audible feedback.

In other embodiments, the controls of a block are symmetrically arrayed, and the block is dimensioned to fit within the span of a user's hand.

In accordance with additional embodiments, the asymmetric interface system is a computer-based system.

In yet other embodiments, the computer-based system is one of a digital audio system, a digital lighting system, a video editing system, and an appliance.

### BRIEF DESCRIPTION OF THE DRAWINGS

The apparatus is described with reference to the accompanying drawings. In the drawings, like reference numbers indicate identical or functionally similar elements. Additionally, the left-most digit(s) of a reference number identifies the drawing in which the reference number first appears.

FIG. 1 shows an exemplary interface panel according to an embodiment of the invention;

FIG. 2 illustrates a digital signal processing control region;

FIG. 3 depicts the mixing process for digital signal process manipulation;

FIG. 4 shows the interface panel with two lines of asymmetry;

FIGS. 5A through 5E show each of the functional control blocks having at least one line of asymmetry; and

FIG. 6 is an illustration of an exemplary interface panel with each functional control block having a unique tactile pattern for an outline.

### DETAILED DESCRIPTION

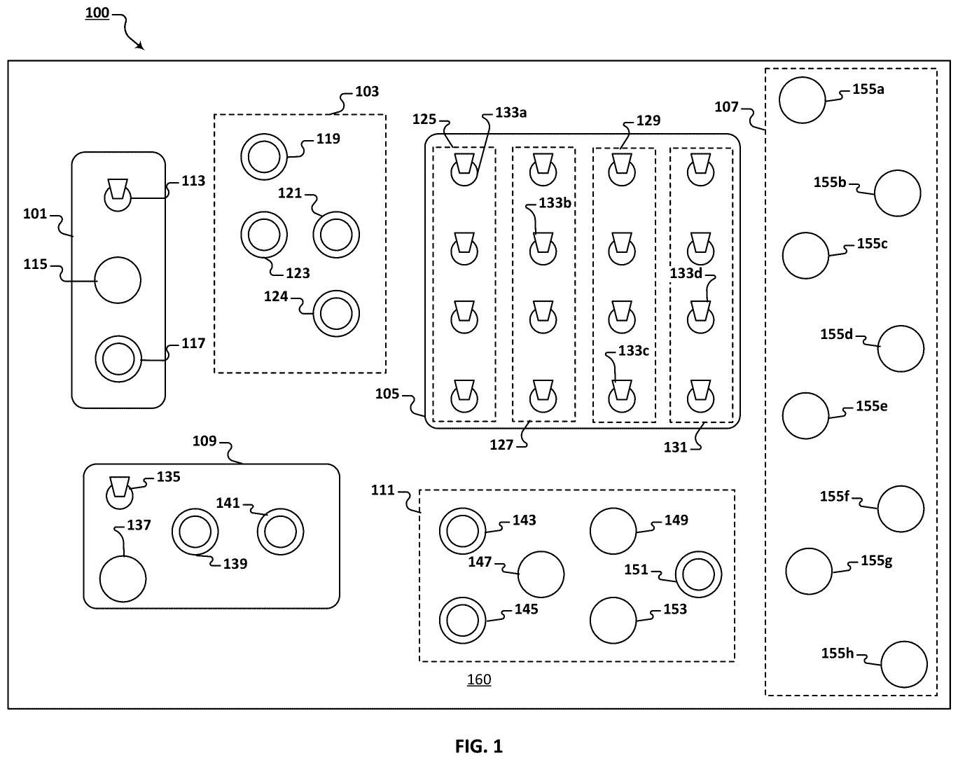

The various embodiments of the system and their advantages are best understood by referring to FIGS. 1 through 6. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

The Asymmetrical Interface System (“AIS”) is a structure and method of designing user interfaces for a variety of software tools. The AIS is a physical and tactile interface that may take a variety of forms, but always relies on the following principles.

The user interface is divided into functional blocks, each giving access to a unique aspect of the underlying system (determined by software mapping). Each functional block of the interface has a different geometry—a unique and recognizable spatial relationship between the interface components.

One aspect of the AIS is that the individual functional block geometries rely on asymmetry—an asymmetrical arrangement of controls within that block. Each functional block will feature a different type of asymmetry. As used herein, “asymmetry” refers to a trait of having two halves that are not the same. In other words, a component is asymmetrical where in may be divided in two in at least one orientation and the two halves are not the same in some way, for example, by size, shape, and spatial relationship or type of parts within the component.

Functional blocks are separated by space and/or orientation guides such that there is a perceptible spatial and tactile delineation between regions of the total interface. Orientation guides feature tactile surfaces to help differentiate the functional bocks. These may include narrow raised strips with unique textures, patterns of raised bumps, etc.

Each functional block of the interface also features unique haptic and audible feedback. Haptic cues are differentiated via different frequencies, durations, and patterns of haptic vibration. Based on the human ability to distinguish different frequencies of haptic vibration, these frequencies would range from sub audio to approximately 1.5 kHz. The waveform of the haptic signal would also be used to differentiate the haptic feedback.

In certain cases, the geometry of a functional block may be symmetrical, as in a matrix of switches and or buttons, but that block will be sized to fit within the span of a typical user's hand, so that the hand may rest on the matrix of controls and access all members of the matrix without moving. Such a matrix will still be spatially separated from other functional blocks, as described above.

Together these features will allow users of the AIS to quickly navigate the interface without relying on visual cues.

The AIS method is applicable to any user interface that features a tactile interface mapped to an underlying computer-based software system. It is especially applicable to interfaces that are used repetitively by users while accomplishing tasks, such that the asymmetry facilitates learning the interface and its associated functions, and when such interfaces need to be navigated without relying on visual cues.

Potential applications of AIS include interfaces designed for digital audio, digital lighting systems, video editing, appliances, and more.

As we enter a world where so much more of our daily life is programmable, including the Internet of Things (IoT), AIS will be beneficial to more and more people, sighted or non-sighted, in their everyday lives.

With reference now to FIG. 1, AIS 100 in the a first embodiment includes panel 160 upon which are arrayed a series of controls for manipulating electronic input. Controls are arranged in a plurality of regions, in this exemplary case, six regions. One region, for example, a digital signal processing (“DSP”) control region 105 comprises a 4×4 matrix of sixteen switches 133a-d arrayed in columns 125, 127, 129, 131 according to DSP chain or sequence, as will be described in greater detail hereafter. Parameter adjustment region 107 comprises a zig-zag column of parameter adjust potentiometers 155a-h for adjusting parameters of the output signal. Parameters may be varied according to the matrix switch 133 activated and DSP algorithm chosen. Parameter adjust potentiometers employ a nulling technique to match current value with previous algorithm settings. Audible feedback lets user know when null point is matched.

Preset control region 111 comprises buttons 143, 145 and 151 and potentiometers 147, 149, 153 for preset configuration, DSP algorithm choice, and preset and audio file volume control. Preset selection region 103 comprises four buttons 119, 121, 123, 124 for selection of DSP algorithm, namely, increment, decrement, preset store and preset recall respectively. DSP algorithms, presented in a list, are accessible via the increment/decrement buttons 119, 121. Menu choice applies to the matrix switch touched in DSP control region 105.

AIS 100 is configured with a voice annunciator for providing indication as to which control is being touched. Voice annunciator control region 101, therefore, comprises an on/off switch 113, a potentiometer 115 for adjusting annunciator volume, and a button 117 for recording voice annunciator notes. It should be noted that in some embodiments, controls in both the DSP control region 105 and parameter adjust region 107 are touch-sensitive, eliciting an audio voice note upon touching the control. The remainder of the controls need not be configured to elicit a voice note based upon touch but upon activation or degree or control input. Performance cue control region 109 comprises a system on/off switch 135 a master volume potentiometer 137 and two buttons 139, 141 for performance cue advance and rewind.

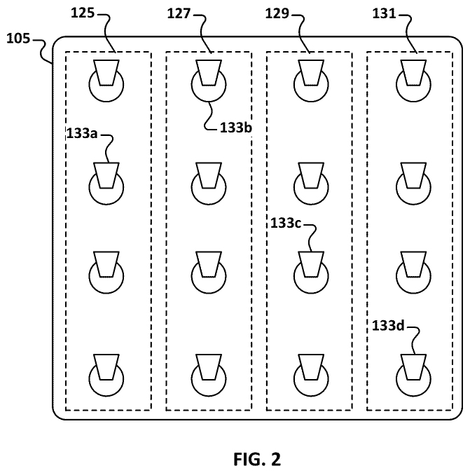

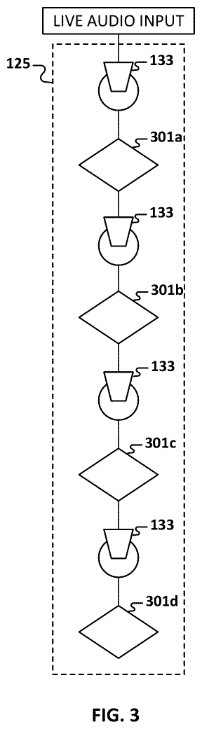

FIG. 2 illustrates DSP control region 105 in greater detail showing switches 133a-d arrayed in columns 125, 127, 129, 131. Switches 133 in column 125 may be configured to provide activation of certain digital signal processing in a chain or sequence. Likewise for the switches 133 in each of columns 127, 129. Switches 133 in column 131 may be configured to activate playback of pre-recorded audio files. Referring to FIG. 3, The DSP matrix features a mix control 301a-d for each stage, represented by DSP control switch 133, of the chain 125, allowing the user to control what percentage of the new output is mixed with prior input. This permits fine adjustment of the digital signal processing for a more nuanced result. It should be noted that while only one chain or column is shown, other columns 127, 129, may also be similarly configured with input mix controls 301a-d.

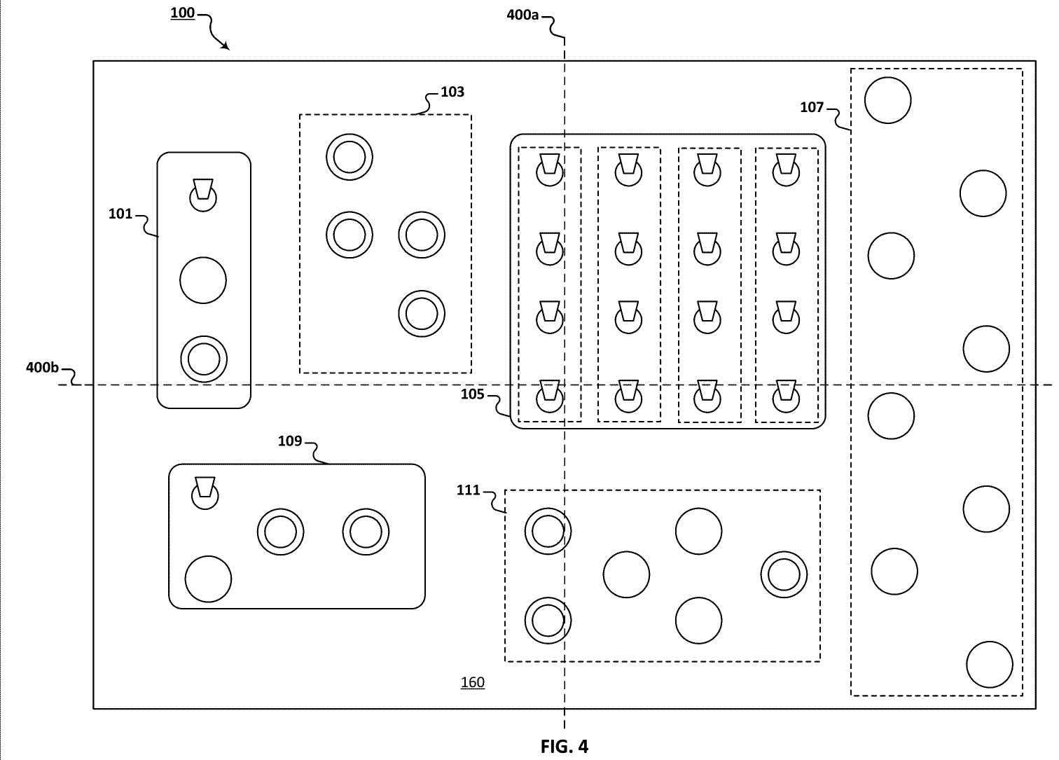

FIG. 4 depicts AIS 100 showing the relationship of functional blocks 101, 103, 105, 107, 109, 111 on panel 160. Vertical and horizontal lines of asymmetry 400a, b show that blocks are arranged on panel 160 asymmetrically such that the upper and lower halves of the panel are asymmetrical, and, likewise, the left and right halves of the panel are asymmetrical. It will be noted that.

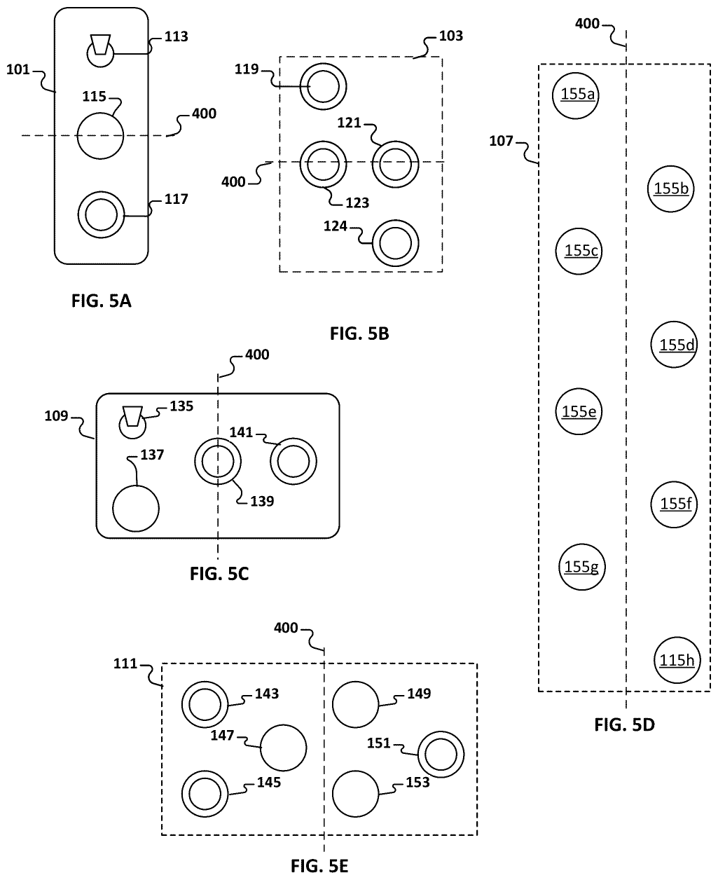

Moving on to FIG. 5A, functional control block 101 comprises a toggle switch 113, a potentiometer 115, and a button 117, and where a line of asymmetry 400 shows upper and lower halves of block 101 are different based upon the type of control within block 101. In FIG. 5B, the controls 119, 121, 123, 124 are all buttons, but are arranged asymmetrically with regard to upper and lower halves of block 103. In FIG. 5C, left and right halves are asymmetrical both in spatial arrangement and control type. Control block 107 in FIG. 5D comprises a plurality of potentiometers 155a-155f arranged in a zigzag so that left and right halves of block 107 are spatially asymmetrical. Finally, FIG. 5E shows control block 111 having on the left half two buttons 143, 145 and a potentiometer 147, while having on the right half two potentiometers 149, 153 and button 151. Accordingly, the two halves are asymmetrical according to type of control.

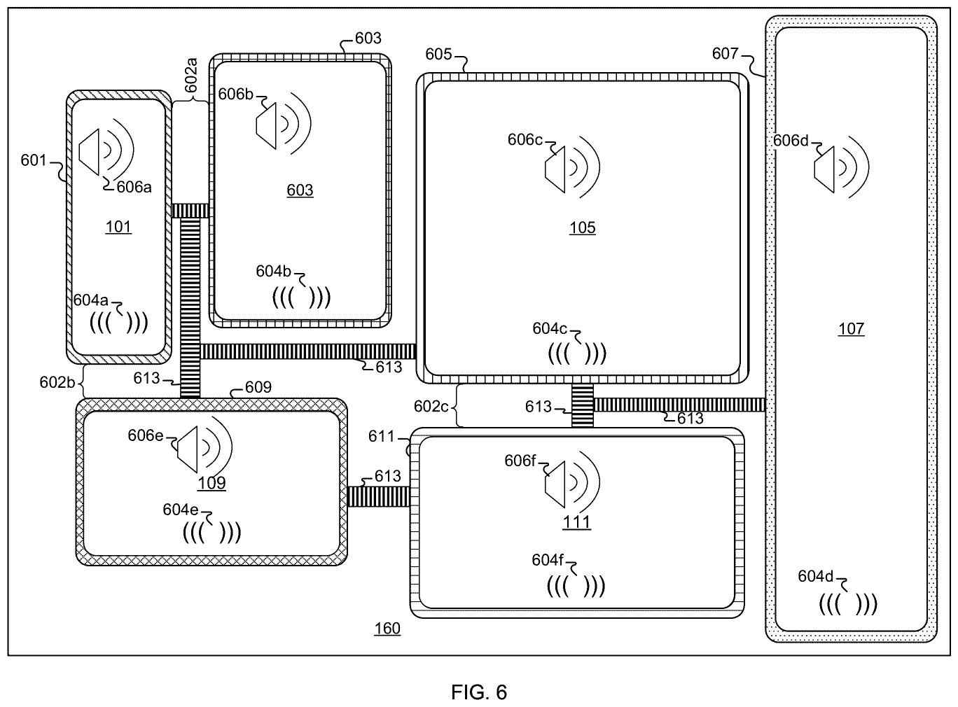

Referring now to FIG. 6, in another embodiment, to aid in navigating panel 160 with limited sight, blocks are delineated by spaces 602a-c. In addition, AIS 100 may comprise functional control blocks 101, 103, 105, 107, 109 bounded by surfaces 601, 603, 605, 607, 609, 611 where each surface is a unique tactile pattern, such as lines, bumps, or checks, to allow tactile identification of a block. The surface of panel 160 may also comprised guide strips 613 that are configured with a textured surface to allow orientation between blocks tactilely.

Each block may be associated with a haptic signal 604a-f that occurs when a control in that block is touched. Each haptic cue is unique to a particular block. Haptic cues are differentiated via different frequencies, durations, and patterns of haptic vibration. Based on the human ability to distinguish different frequencies of haptic vibration, these frequencies would range from sub audio to approximately 1.5 kHz.

To further allow identification of a functional control block, each functional control block may also be associated with an audio cue 606a-f that emits upon selection of a control within a block. As with haptic cues 604a-f, audio cues 606a-f may be unique to each block, including various frequencies, tones, timbres, and may include a voice. In addition, it will be noted that blocks 101, 103, 105, 107, 111 may be varied in size and shape further enhancing the ability to distinguish one block from another.

As described above and shown in the associated drawings, the present invention comprises an asymmetric interface system. While particular embodiments have been described, it will be understood, however, that any invention appertaining to the system described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. An asymmetric interface for manipulating a system comprising:
a panel supporting a plurality of controls, the plurality of controls being divided into a plurality of blocks based upon underlying system function; and
wherein the blocks are arranged asymmetrically with respect to each other; and
wherein the controls within each block have a unique arrangement with respect to an arrangement of controls in other blocks.

2. The asymmetric interface system of claim 1, wherein the controls of at least some of the plurality of blocks have an asymmetric relationship to each other.

3. The asymmetric interface system of claim 1, wherein each of the plurality of blocks is separated by a space to delineate between blocks.

4. The asymmetric interface system of claim 1, further comprising orientation guides disposed between blocks such that there is tactile delineation among the blocks, each orientation guide comprising a unique tactile surface to differentiate the blocks.

5. The asymmetric interface system of claim 1, wherein each block comprises a unique tactile surface that includes a unique texture.

6. The asymmetric interface system of claim 1, wherein each block is configured with a unique haptic cue.

7. The asymmetric interface system of claim 6, wherein the haptic cue may be varied by at least one of frequency, duration, waveform, and pattern vibration.

8. The asymmetric interface system of claim 7, wherein vibration frequency may be between sub audio to about 1.5 kHz.

9. The asymmetric interface system of claim 1, wherein each block is configured with a unique audible cue.

10. The asymmetric interface system of claim 1, wherein the controls of at least one block are symmetrically arrayed and the block is dimensioned to fit within a span of a user's hand.

11. The asymmetric interface system of claim 1, wherein the system is a computer-based system.

12. The asymmetric interface system of claim 11, wherein the computer-based system if one of a digital audio system, a digital lighting system, a video editing system, and an appliance.

13. A method for allowing access and control of a computer-based system comprising the step of:
the asymmetric interface system of claim 1.

14. The method of claim 13, wherein the system is a computer-based system.

15. The method of claim 14, wherein the computer-based system if one of a digital audio system, a digital lighting system, a video editing system, and an appliance.

16. The method of claim 13, wherein controls of at least some of the plurality of blocks have an asymmetric relationship to each other.

17. The method of claim 13, wherein each of the plurality of blocks is separated by a space to delineate between blocks.

18. The method of claim 13, further comprising orientation guides disposed between blocks such that there tactile delineation between blocks each orientation guide comprising a unique tactile surface to differentiate the blocks.

19. The method of claim 13, wherein each block comprises a unique tactile surface that includes at least one of unique textures and patterns of raised bumps.

20. The method of claim 13, wherein each block is configured with a unique haptic cue.
